(19) United States
(12) Patent Application Publication
(10) Pub. No.: US 2023/0303026 A1
(43) Pub. Date: Sep. 28, 2023

(54) FORMING METHOD AND INSTRUMENT PANEL

(71) Applicant: HONDA MOTOR CO., LTD., Tokyo (JP)

(72) Inventors: Toshihisa KAGA, Tokyo (JP); Toshiaki ONO, Tokyo (JP); Takaaki NAGATA, Tokyo (JP); Shoichiro NEGISHI, Tokyo (JP)

(21) Appl. No.: 18/173,083

(22) Filed: Feb. 23, 2023

(30) Foreign Application Priority Data
Mar. 24, 2022 (CN) 202210298059.8

(51) Int. Cl. B60R 21/2165; B60R 21/205; B29C 45/00

(52) U.S. Cl. CPC B60R 21/2165; B60R 21/205; B29C 45/0081; B29L 2031/3038

(57) ABSTRACT

Provided are a forming method of forming, with high efficiency, a tear line groove even with a layout of unsuitable for processing for drawing a locus in a unicursal manner, and an instrument panel formed by the forming method. The forming method is a method of forming a tear line groove in an airbag deployment portion, the tear line groove including: an airbag deployment portion forming step of applying, as one die of two dies constituting a cavity into which a molten resin is injected to form the airbag deployment portion, a die having a ridge protruding inwardly in the cavity to form a part of the tear line groove; and a post-processing step of processing the remaining tear line groove, which were not formed in the airbag deployment portion forming step.

This application is based on and claims the benefit of priority from Chinese Patent Application No. 202210298059.8, filed on 24 Mar. 2022, the content of which is incorporated herein by reference.

### BACKGROUND OF THE INVENTION

### Field of the Invention

The present invention relates to a forming method and an instrument panel formed by the forming method.

### Related Art

On a rear surface of an airbag deployment portion of an instrument panel, a tear line groove is formed which is a fragile portion against an inflation force of an airbag. When the airbag inflates, the airbag deployment portion is torn along the tear line groove. Conventionally, a layout of the tear line groove has a form in which one central tear line groove connecting centers of two end sides facing each other is added to a tear line groove forming end sides of a quadrilateral. A technique has been proposed for forming such a tear line groove with the conventional layout using a laser processing apparatus (see Japanese Unexamined Patent Application, Publication No. H11-291069).

Patent Document 1: Japanese Unexamined Patent Application, Publication No. H11-291069

### SUMMARY OF THE INVENTION

In the technique disclosed in Japanese Unexamined Patent Application, Publication No. H11-291069, the tear line groove with the conventional layout can be continuously processed so as to draw a locus in a unicursal manner, and productivity is high. On the other hand, in recent years, a tear line groove with a new layout is being adopted which is superior to the tear line groove with the conventional layout in terms of deployment performance of an airbag. However, the tear line groove with the new layout cannot be continuously processed using the technique disclosed in Japanese Unexamined Patent Application, Publication No. H11-291069. For this reason, there is a problem in terms of productivity.

The present invention has been made in view of the above circumstances, and is to provide a method of forming, with high efficiency, a tear line groove with a layout, which has excellent deployment performance of an airbag but is not suitable for processing for drawing a locus in a unicursal manner, and an instrument panel formed by the forming method.

In the present disclosure, for the sake of convenience, the form will be described based on a Y-shape. Respective portions of the Y-shape used in the description are designated by explanatory notes in FIG. 9, and terms of the disclosure conforms to the explanatory notes.

(1) A first aspect of the present disclosure relates to a forming method of a tear line groove (for example, a tear line groove 4 to be described below), which is a fragile portion against an inflation force of an airbag (for example, an airbag 2 to be described below), in an airbag deployment portion (for example, an airbag deployment portion 3 to be described below) of an instrument panel (for example, an instrument panel 1 to be described below),
the tear line groove including: a central portion (for example, a central portion 43 to be described below) having a shape in which bottom points (for example, bottom points 41d and 42d to be described below) of two Y-shapes are connected to each other such that stems (for example, stems 41c and 42c to be described below) of the two Y-shapes (for example, one Y-shape 41 and the other Y-shape 42 to be described below) are aligned in a straight line; and four end sides (for example, end sides 441, 442, 443, and 444 to be described below) of a quadrilateral (for example, a quadrilateral 44 to be described below) formed by connecting branch end points (for example, branch end points 411, 412, 421, and 422 to be described below) of one of the Y-shapes and the other of the Y-shapes in the shape of the central portion,
the method comprising: an airbag deployment portion forming step (for example, an airbag deployment portion forming step S1 to be described below) of applying, as one die (for example, a movable die 51 to be described below) of two dies (for example, movable die 51 and fixed die 52 to be described below) constituting a cavity (for example, a cavity 53 to be described below) into which a molten resin is injected to form the airbag deployment portion, a die having a ridge (for example, a ridge 511 to be described below) protruding inwardly in the cavity, to form two parallel end sides (for example, an end side 441 and an end side 442 to be described below) of the four end sides or to form two branches including one branch of left or right branch (for example, a left branch 42a or a right branch 42b to be described below) of the one Y-shape and any one of left or right branch of the other Y-shape; and
a post-processing step (for example, a post-processing step S2 to be described below) of processing the remaining tear line groove, which were not formed in the airbag deployment portion forming step.

(2) A second aspect of the present disclosure relates to the forming method as described in the first aspect, in which the ridge of the one die used in the airbag deployment portion forming step is formed by arranging a slide core or an insert (for example, an insert Ins to be described below).

(3) A third aspect of the present disclosure relates to the forming method as described in the first aspect, in which the two end sides (for example, end sides 441 and 442 to be described below) facing each other are formed in the airbag deployment portion forming step, and
the remaining end sides are processed in the post-processing step, including overlap processing (for example, an overlap processing portion Ov to be described below) in which processing is performed in a state that the remaining side ends partially overlap with the two end sides which were formed in the airbag deployment portion forming step and which face each other.

(4) A fourth aspect of the present disclosure relates to the forming method as described in the third aspect, in which among the tear line grooves, a groove width of the tear line groove subjected to the overlap processing is processed so as to be larger than a groove width of the tear line groove not subjected to the overlap processing.

(5) A fifth aspect of the present disclosure relates to an instrument panel (for example, an instrument panel 1 to be described below) in which a tear line groove (for example, a tear line groove 4 to be described below), which is a fragile portion against an inflation force of an airbag, is formed in an airbag deployment portion,
the tear line groove including: a central portion (for example, a central portion 43 to be described below) having a shape in which bottom points of two Y-shapes (for example, bottom points 41d and 42d to be described below) are connected to each other such that stems (for example, stems 41c and 42c to be described below) of the two Y-shapes (for example, one Y-shape 41 and the other Y-shape 42 to be described below) are aligned in a straight line; and
four end sides (for example, end sides 441, 442, 443, and 444 to be described below) of a quadrilateral (for example, a quadrilateral 44 to be described below) formed by connecting branch end points (for example, branch end points 411, 412, 421, and 422 to be described below) of one of the Y-shapes and
the other of the Y-shapes in the shape of the central portion, the tear line groove in a vicinity of each of branch end points of the one Y-shape and the other Y-shape having a groove width larger than a groove width of the tear line groove in other portions.

(6) A sixth aspect of the present disclosure relates to the instrument panel as described in the fifth aspect, in which the groove width of the tear line groove in the vicinity of each of the branch end points of the one Y-shape and the other Y-shape is twice or less than the groove width of the tear line groove in the other portions.

(7) A seventh aspect of the present disclosure relates to the instrument panel as described in the sixth aspect, in which the central portion and the two end sides facing each other in the tear line groove form a groove that has substantially a U-shape (for example, a U-shaped groove 311 to be described below) in cross section, and a tapered shape (for example, a tapered portion 312 to be described below) is formed near a groove opening.

(8) An eighth aspect of the present disclosure relates to the instrument panel as described in the fifth aspect, in which other portions of the tear line groove excepting the central portion and some of the four end sides continue to each other in a unicursal shape (for example, a unicursal A to be described below).

(9) A ninth aspect of the present disclosure relates to a forming method of a tear line groove (for example, a tear line groove 4 to be described below), which is a fragile portion against an inflation force of an airbag (for example, an airbag 2 to be described below), in an airbag deployment portion (for example, an airbag deployment portion 3 to be described below) of an instrument panel,
an airbag deployment portion forming step (for example, an airbag deployment portion forming step S1 to be described below) of applying, as one die (for example, a movable die 51 to be described below) of two dies (for example, movable die 51 and fixed die 52 to be described below) constituting a cavity (for example, a cavity 53 to be described below) into which a molten resin is injected to form the airbag deployment portion, a die (for example, a movable die 51 to be described below) having a ridge (for example, a ridge 511 to be described below) protruding inwardly in the cavity to form a part of the tear line groove; and
a post-processing step (for example, a post-processing step S2 to be described below) of processing the remaining tear line groove, which were not formed in the airbag deployment portion forming step.

(10) A tenth aspect of the present disclosure relates to the forming method as described in the ninth aspect, in which the tear line groove has a first groove portion (for example, the machining line drawn in bold in the figures) having a shape that allows unicursal writing among the tear line groove, and a second groove portion (for example, the linear part drawn with a thin line in the figures) having a remaining shape that cannot be written with a unicursal writing of the tear line groove, and wherein in the airbag deployment portion forming step, the second groove portion is formed, and in the post-processing step, the first groove portion is machined.

According to the forming method of (1), in the tear line groove, the portions of the tear line groove that cannot be processed in a unicursal manner in the post-processing step are formed in advance in the airbag deployment portion forming step. For this reason, the portions of the tear line groove to be processed after the airbag deployment portion forming step presents a series of paths suitable for processing in a unicursal manner, and can be formed at once. Thus, the forming time of the tear line groove can be shortened.

According to the forming method of (2), since the ridge of the one die used in the airbag deployment portion forming step is formed by arranging an insert, the shape and dimensions of the tear line groove corresponding to the insert can be managed with high accuracy.

According to the forming method of (3), the tear line groove is processed in the post-processing step by partially overlapping the two end sides which face each other and are formed in the airbag deployment portion forming step. Since the processed portion of the tear line groove is partially overlapped in the airbag deployment portion forming step and the post-processing step, the tear line groove can be reliably connected. Therefore, the deployment performance of the airbag can be ensured.

According to the forming method of (4), the groove width of the tear line groove subjected to the overlap processing is larger than the groove width of the tear line groove not subjected to the overlap processing. Therefore, the tolerance of the processing position in the post-processing step is absorbed by the groove width of the portion subjected to the overlap processing, whereby the tear line groove can be reliably connected.

According to the instrument panel of (5), since the tear line groove in the vicinity of the branch end points of the Y-shapes has the groove width larger than that of the tear line groove in the other portions, the tear line groove is reliably formed to be connected when the vicinity is defined as a boundary region between the portion formed in the airbag deployment portion forming step and the portion formed in the post-processing step.

According to the instrument panel of (6), since the groove width of the tear line groove in the vicinity of the branch end points of the one Y-shape and the other Y-shape is twice or less than twice the groove width of tear line groove in the other portions, the tear line groove is reliably formed to be connected.

According to the instrument panel of (7), since the central portion and the two end sides facing each other in the tear line groove form a groove that has substantially a U-shape in cross section and the tapered shape is formed near the groove opening, fragility of the tear line groove to the inflation force of the airbag is moderate, and deployment performance of the airbag can be ensured.

According to the instrument panel of (8), the portions of the tear line groove, which continue in the unicursal manner, can be formed at once in the post-processing step. Thus, the forming time of the tear line groove can be shortened.

According to the forming method of (9), a part of the tear line groove are formed in advance in the airbag deployment portion forming step. For this reason, the forming time of the tear line groove can be shortened.

According to the forming method of (10), second groove portion, which has a shape that cannot be written with a unicursal writing of the tear line groove, are formed in advance in the airbag deployment portion forming step. For this reason, a first groove portion, which has a shape that allows unicursal writing among the tear line groove, are processed in a unicursal manner, and can be formed at once. Thus, the forming time of the tear line groove can be shortened.

### BRIEF DESCRIPTION OF THE DRAWINGS

FIG. 1 is a schematic diagram showing an instrument panel according to an embodiment of the present invention;

FIG. 2 is a diagram of an airbag deployment portion as viewed from a rear surface side in the instrument panel shown in FIG. 1;

FIG. 3 is a process diagram showing a forming method according to an embodiment of the present invention;

FIG. 4 is a diagram for describing a die applied to an airbag deployment portion forming step in the forming method in FIG. 3.

FIG. 5 is a diagram for describing end milling in a post-step in the forming method in FIG. 3;

FIG. 6A is a diagram for describing an example of a processing line in the end milling in FIG. 5;

FIG. 6B is a diagram for describing another example of a processing line in the end milling in FIG. 5;

FIG. 6C is a diagram for describing further another example of a processing line in the end milling in FIG. 5;

FIG. 6D is a diagram for describing further another example of a processing line in the end milling in FIG. 5;

FIG. 7 is a partially enlarged view of a FIG. 6A;

FIG. 8 is a diagram for describing an overlap processing portion in a tear line groove; and

FIG. 9 is a diagram showing explanatory notes regarding respective portions of a Y-shape used in the description of the present disclosure.

### DETAILED DESCRIPTION OF THE INVENTION

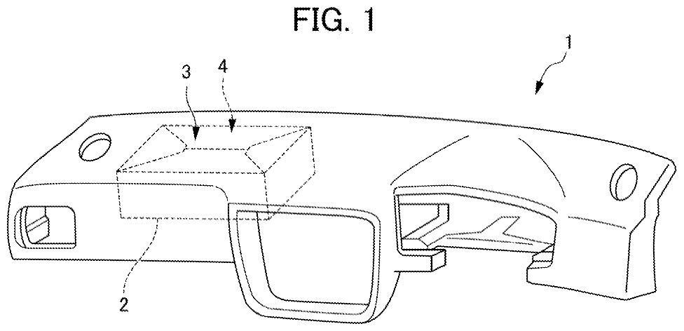

An embodiment of the present invention will be described below with reference to the drawings. FIG. 1 is a schematic diagram showing an instrument panel 1 according to an embodiment of the present invention. An airbag 2 is housed directly under a rear surface side of the instrument panel 1. A portion of the instrument panel 1 directly above the airbag 2 is an airbag deployment portion 3. The airbag deployment portion 3 is torn by an inflation pressure of the airbag 2, and the airbag 2 can be deployed normally. The airbag deployment portion 3 has a tear line groove 4 formed on a rear surface thereof, which becomes a fragile portion against an inflation force of the airbag 2.

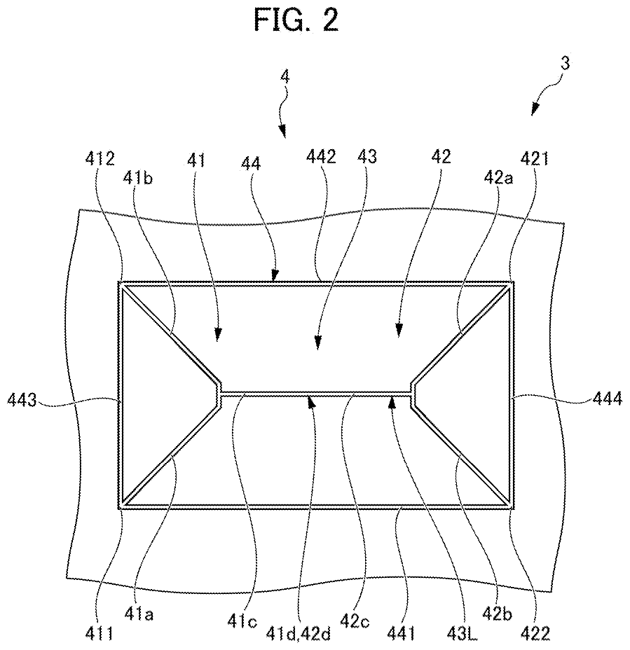

FIG. 2 is a diagram of the airbag deployment portion 3 as viewed from the rear surface. In order to avoid complication of expression, geometrical shapes and processing paths of respective portions of the tear line groove 4 are appropriately referred to as the tear line groove 4 itself with names.

Referring to FIG. 2, the tear line groove 4 has a central portion 43 having a shape in which bottom points 41d and 42d are connected to each other such that a stem 41c of one Y-shape 41 and a stem 42c of the other Y-shape 42 are aligned in a straight line. The tear line groove 4 also has four end sides 441, 442, 443, and 444 of a quadrilateral 44 formed by connecting branch end points 411 and 412 of one Y-shape and branch end points 421 and 422 of the other Y-shape 42 in the shape of the central portion 43.

It should be noted here that the shape of the tear line groove is not necessarily limited to that shown in FIG. 2. That is, the shape of the tear line groove shown in FIG. 2 is just one example, and this shape can take any form. Preferably, the tear line groove 4 has a shape that cannot be written with a unicursal writing, so that the tear line groove 4 can be divided into a first groove portion (for example, the machining line drawn in bold in the figures) having a shape that allows unicursal writing among the tear line groove, and a second groove portion (for example, the linear part drawn with a thin line in the figures) having a remaining shape that cannot be written with a unicursal writing of the tear line groove.

In other words, the tear line groove 4 is configured by the central portion 43 and the four end sides 441, 442, 443, and 444. The central portion 43 includes a left branch 41a, a right branch 41b, and a stem 41c in one Y-shape 41, and a left branch 42a, a right branch 42b, and a stem 42c in the other Y-shape 42. The stem 41c and the stem 42c are connected to each other at the bottom point 41d of the one Y-shape 41 and the bottom point 42d of the other Y-shape 42 to form one central straight portion 43L.

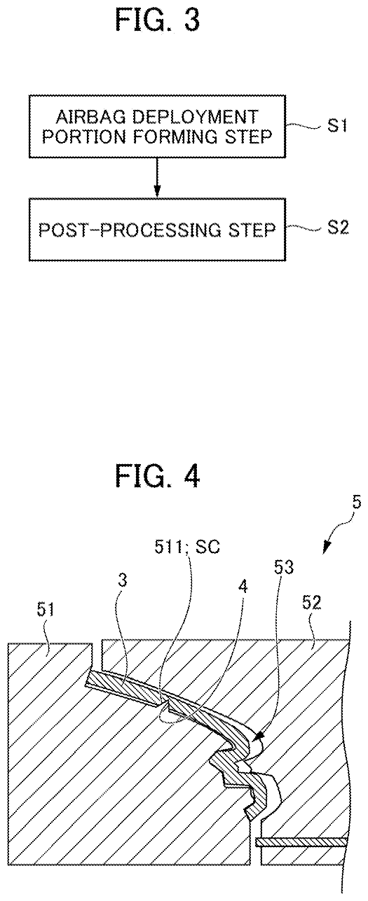

FIG. 3 is a process diagram showing a forming method of forming the tear line groove 4 shown in FIG. 2. The forming method includes airbag deployment portion forming step S1 and a post-processing step S2. In the airbag deployment portion forming step S1, when the airbag deployment portion 3 of the instrument panel 1 is formed by a die, a part of the tear line groove 4 is formed at the same time. In other words, the pair of end sides 441 and 442 facing each other of the four end sides 441, 442, 443, and 444 of the quadrilateral 44 in the tear line groove 4 shown in FIG. 2 are formed by a die. In the post-processing step S2, the remaining parts of the tear line groove 4 not formed in the deployment portion forming step S1 are formed.

FIG. 4 is a diagram for describing a die 5 applied to the airbag deployment portion forming step S1 in FIG. 3. FIG. 4 shows a portion of the die 5 that functions to form the airbag deployment portion 3 by a die. The die 5 includes a movable die 51 and a fixed die 52. A cavity 53 is formed between facing surfaces of the movable die 51 and the fixed die 52 facing each other. A portion of the instrument panel 1 including the airbag deployment portion 3 is die-clamped and formed in the cavity 53. The movable die 51 has a ridge 511 protruding inwardly of the cavity 53 to form the tear line groove 4. As the movable die 51, a mode may be applied in which the ridge 511 is a retractable slide core SC that advances after molten resin is injected into the cavity 53 to form the tear line groove 4, and then retracts. In the case of adopting such a mode, a shape and a depth of the tear line groove 4 corresponding to the slide core SC are easily managed with high accuracy. As the movable die 51, a mode can also be adopted in which the ridge 511 is an insert.

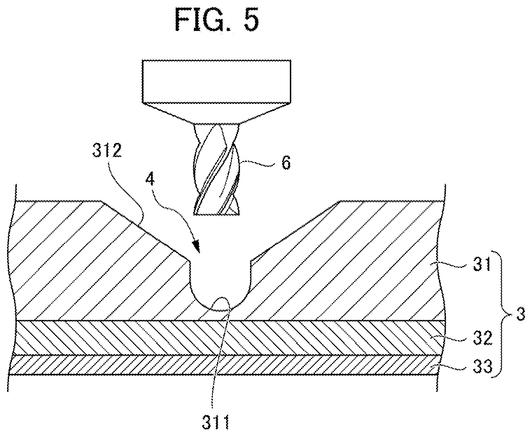

FIG. 5 is a diagram for describing the post-processing step S2 in FIG. 3. In the post-processing step S2, the tear line groove 4 is formed by end milling on a rear surface of the airbag deployment portion 3 formed in the airbag deployment portion forming step S1. The airbag deployment portion 3 is formed in which a base material layer 31, a foam layer 32, and a skin layer 33 are laminated in this order. The tear line groove 4 is formed by an end mill 6 from the base material layer 31 side on the rear surface of the airbag deployment portion 3.

In the tear line groove 4, the central portion 43 in FIG. 2 formed in the post-processing step S2 and the end sides 443 and 444 as two short sides facing each other form a U-shaped groove 311 having a substantially U-shaped deep portion as seen in cross-section, and a tapered portion 312 having a tapered shape is formed in the vicinity of the groove opening. The depth of the U-shaped groove 311 does not reach the skin layer 33, but approaches close to the foam layer 32 in the shown example. Since the shape of the tear line groove 4 has the U-shaped groove 311 and the tapered portion 312, fragility of the tear line groove 4 to the inflation force of the airbag is moderate, and deployment performance of the airbag can be ensured.

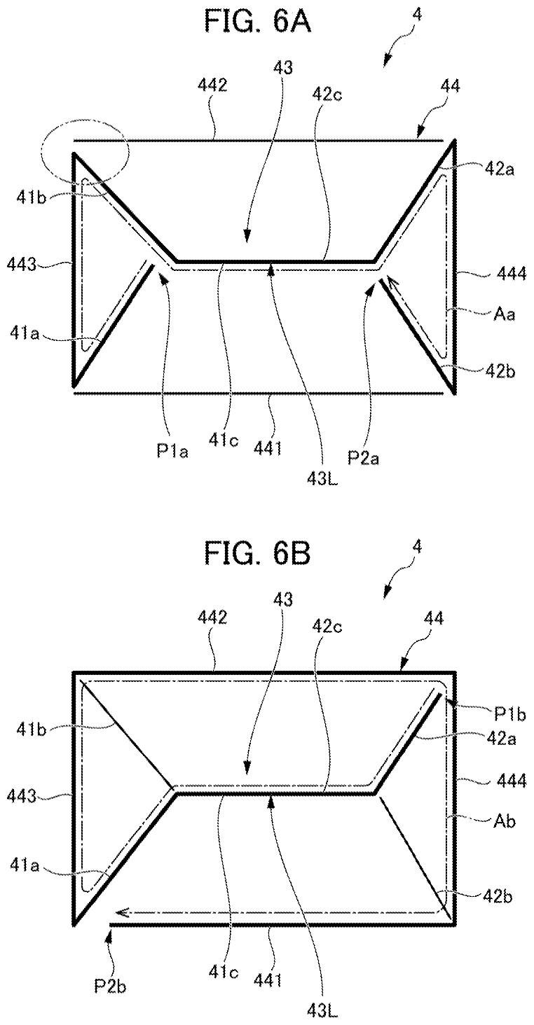

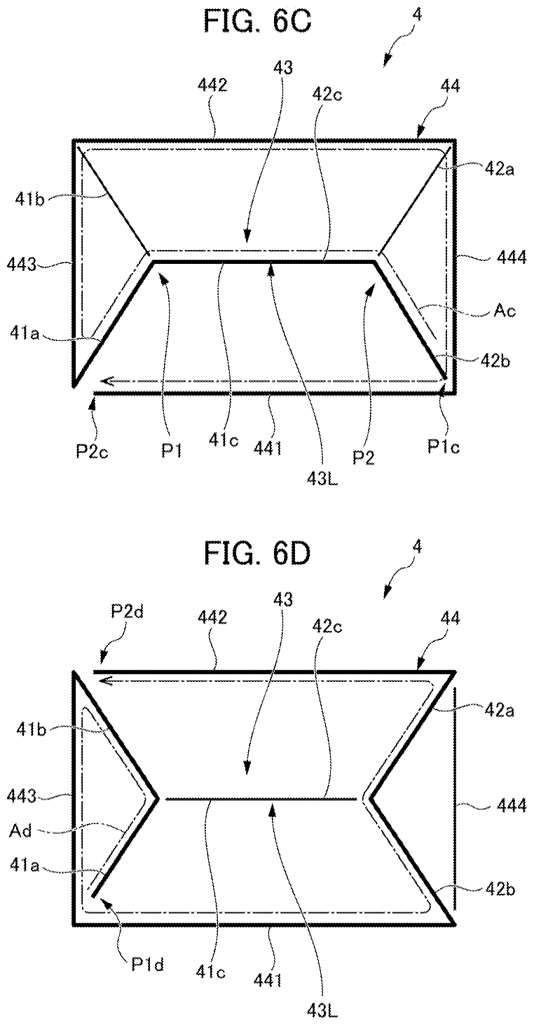

FIG. 6A is a diagram for describing an example of a processing line, which is a moving locus of the end mill 6 in the end milling in FIG. 5. Although FIG. 6A shows a processing line, for convenience of description, respective portions will be described using the reference numerals attached to the respective portions of the tear line groove 4 itself in FIG. 2. In the end milling in the post-processing step S2, the tear line groove 4 is processed along the processing line continuously extending from a start point P1a to an end point P2a shown in the following order. Specifically, a processing line is drawn to reach the end point P2a through the left branch 41a, the end side 443, the right branch 41b, the central straight portion 43L, the left branch 42a, the end side 444, and the right branch 42b in this order from an end on the stem 42c of the left branch 41a as the start point P1a, and end milling is performed along the processing line. The parallel end sides 411 and 412 of the tear line groove 4, which do not correspond to the processing line for the end milling, are portions formed by the die 5 in the airbag deployment portion forming step S1. When the tear line groove 4 is formed with reference to FIG. 6A, the end sides 411 and 412, which are pivot axes during deployment of the airbag are formed by the die 5 in the airbag deployment portion forming step S1. Where the central portion 43 to be torn is processed with an end mill, due to the fact that the portion processed with the end mill is easily torn, the deployment of the airbag can be stabilized.

FIGS. 6B, 6C and 6D are diagrams for describing examples of processing lines, respectively, which are moving loci of the end mill 6 in the end milling in FIG. 5. In the example of FIG. 6B, a processing line is drawn to reach an end point P2b through the left branch 42a, the central straight portion 43L, the left branch 41a, the end side 443, the end side 442, the end side 444, and the end side 441 in this order from the branch end point of the left branch 42a as a start point P1b, and end milling is performed along the processing line. The right branch 41b and the right branch 42b of the tear line groove 4, which do not correspond to the processing line for the end milling, are portions formed by the die 5 in the airbag deployment portion forming step S1.

In the example of FIG. 6C, a processing line is drawn to reach an end point P2b through the right branch 42b, the central straight portion 43L, the left branch 41a, the end side 443, the end side 443, the end side 443, the end side 442, the end side 444, and the end side 441 in this order from the branch end point of the right branch 42b as a start point P1c, and end milling is performed along the processing line. The right branch 41b and the left branch 42a of the tear line groove 4, which do not correspond to the processing line for the end milling, are portions formed by the die 5 in the airbag deployment portion forming step S1.

In the example of FIG. 6D, a processing line is drawn to reach an end point P2d through the left branch 41a, the right branch 41b, the end side 443, the end side 441, the right branch 42b, the left branch 42a, and the end side 442 in this order from the branch end point of the left branch 41a as a start point P1d, and end milling is performed along the processing line. The central straight portion 43L and the end side 444 of the tear line groove 4, which do not correspond to the processing line for the end milling, are portions formed by the die 5 in the airbag deployment portion forming step S1. The examples of FIGS. 6B, 6C, and 6D also have the same effect with respect to the example of FIG. 6A that the forming time of the tear line groove 4 can be shortened.

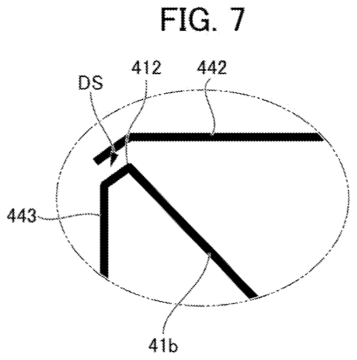

The inventors have conducted various experiments, and have found further improvement points regarding the processing line at the time of forming the tear line groove 4 with end milling. The improvement points will be described below with reference to FIG. 7. FIG. 7 shows an enlarged view of one corner of the quadrilateral 44 in FIG. 6A. The end mill 6 moves so as to draw a processing line from the end side 443 toward a left end of one end side 442 which has been already formed, and the processing line is folded back in a direction of inclination along the right branch 41b from the position of the branch end point 412 of the right branch 41b. There is a tolerance in management accuracy of a moving position of the end mill 6. For this reason, it has been found that when the end mill 6 moves by folding back the processing line, the folding-back cutting locus does not reach the one end site of the end side 442, and a discontinuous portion DS may occur.

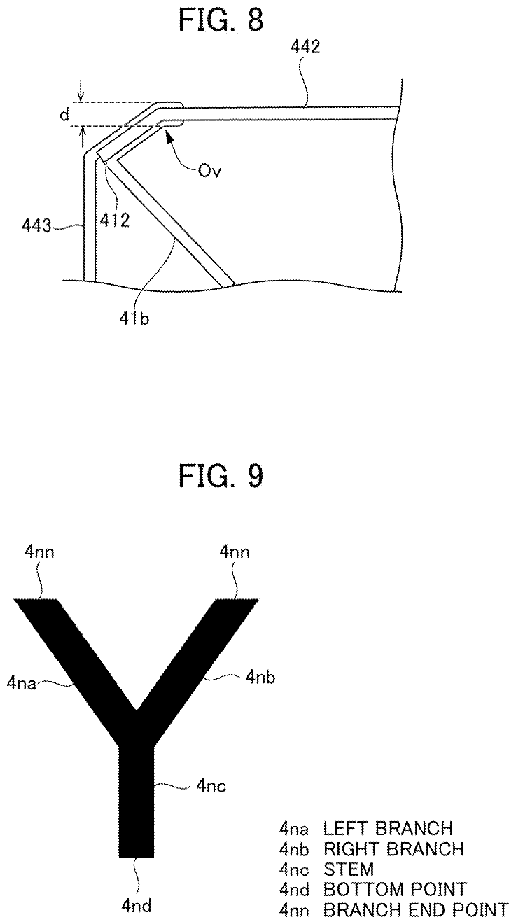

Referring to FIG. 8, a method of preventing the discontinuous portion DS in FIG. 7 from occurring will be described below. In the method of FIG. 8, the end mill 6 moves so as to draw a processing line from the end side 443 toward a left end of the end side 442, but the processing line is not folded back immediately in a direction of inclination along the right branch 41b from the position of the branch end point 412 of the right branch 41b.

In other words, overlap processing is performed in which the end mill 6 is once wrapped around a part of a section of the end side 442 and moves from the position of the branch end point 412 of the right branch 41b so as to overlap the left end of the end side 442. Thereafter, the direction of movement is reversed, and the end mill 6 is moved so as to return to the position of the branch end point 412 of the right branch 41b. A groove width d of an overlap portion Ov of the tear line groove 4 formed by overlap processing is processed so as to be larger than and twice or less a groove width of the tear line groove 4 in the portions not subjected to overlap processing. Thus, according to the method of FIG. 8, the discontinuous portion DS does not occur unlike the method of FIG. 7. The groove width d of the overlap portion Ov according to the method of FIG. 8 is similarly set for any one of vicinities of the four branch end points 411, 412, 421, and 422.

According to the forming method and the instrument panel of the present embodiment, the following effects are achieved.

The forming method of (1) is a method of forming the tear line groove 4, which is the fragile portion against the inflation force of the airbag 2, in the airbag deployment portion 3 of the instrument panel 1, the tear line groove 4 including: the central portion 43 having the shape in which the bottom points 41d and 42d are connected to each other such that the stem 41c of one Y-shape 41 and the stem 42c of the other Y-shape 42 are aligned in the straight line; and the four end sides 441, 442, 443, and 444 of the quadrilateral 44 formed by connecting the branch end points 411, 412, 421, and 422 of the one of Y-shapes and the other of Y-shapes in the shape of the central portion 43, the forming method including: the airbag deployment portion forming step S1 of applying the die 5 having the ridge 511 protruding inwardly of the cavity 53 to form one or two end sides of the four end sides 441, 442, 443, and 444, as the movable die 51 of the movable die 51 and the fixed die 52 constituting the cavity 53 into which the molten resin is injected to form the airbag deployment portion 3; and the post-processing step S2 of processing the central portion 43 and the end sides remaining, which are not formed in the airbag deployment portion forming step S1, of the four end sides 441, 442, 443, and 444 of the tear line groove 4 in the airbag deployment portion 3 formed in the airbag deployment portion forming step S1. In the tear line groove 4, the portions of the tear line groove that cannot be processed in a unicursal manner in the post-processing step S2 are formed in advance in the airbag deployment portion forming step S1. For this reason, the portions of the tear line groove to be processed after the airbag deployment portion forming step presents a series of paths suitable for processing in a unicursal manner, and can be formed at once. Thus, the forming time of the tear line groove can be shortened.

In the forming method of (2), the ridge 511 of the movable die 51 used in the airbag deployment portion forming step S1 is formed by arranging an insert Ins. Therefore, the shape and dimensions of the tear line groove 4 corresponding to the insert Ins can be managed with high accuracy.

In the forming method of (3), the two end sides 441 and 442 facing each other are formed in the airbag deployment portion forming step S1, and the end sides remaining including the overlap processing portion Ov are processed in the post-processing step S2, the overlap processing portion Ov being processed by partially overlapping the two end sides 441 and 442 which face each other and are formed in the airbag deployment portion forming step S1. Therefore, the tear line groove can be reliably connected, and the deployment performance of the airbag can be ensured.

In the forming method of (4), the groove width of the tear line groove 4 subjected to overlap processing is processed so as to be larger than the groove width of the tear line groove not subjected to overlap processing. Therefore, the tolerance of the processing position in the post-processing step S2 is absorbed by the groove width of the portion subjected to the overlap processing, whereby the tear line groove 4 can be reliably connected.

The instrument panel 1 of (5) includes the tear line groove 4, which is the fragile portion against the inflation force of the airbag, and is formed in the airbag deployment portion, the tear line groove 4 including: the central portion 43 having the shape in which the bottom points 41d and 42d are connected to each other such that the stem 41c of one Y-shape 41 and the stem 42c of the other Y-shape 42 are aligned in the straight line; and the four end sides 441, 442, 443, and 444 of the quadrilateral 44 formed by connecting the branch end points 411, 412, 421, and 422 of the one Y-shape 41 and the other Y-shape 42 in the shape of the central portion 43, the tear line groove in the vicinity of the branch end points 411, 412, 421, and 422 of the one Y-shape 41 and the other Y-shape 42 having the groove width larger than that of the tear line groove in the other portions. Therefore, the tear line groove 4 is reliably formed to be connected when the vicinity is defined as a boundary region between the portion formed in the airbag deployment portion forming step S1 and the portion formed in the post-processing step S2.

In the instrument panel 1 of (6), since the groove width of the vicinity of the branch end points 411, 412, 421, and 422 of the one Y-shape 41 and the other Y-shape 42 is twice or less than twice the groove width of the other portions, the tear line groove is reliably formed to be connected.

In the instrument panel 1 of (7), the central portion 43 and the end sides 443 and 444 which are two short sides facing each other in the tear line groove 4 form a U-shaped groove 311 that has substantially a U-shape as seen in cross section, and the tapered portion 312 having a tapered shape is formed near the groove opening. Therefore, fragility of the tear line groove 4 to the inflation force of the airbag is moderate, and deployment performance of the airbag can be ensured.

In the instrument panel 1 of (8), the other portions of the tear line groove 4 excepting the central portion 43 and some of the four end sides 441, 442, 443, and 444 continue to each other in a unicursal shape (FIG. 6A). Therefore, the portions, which continue in the unicursal shape, can be formed at once in the post-processing step S2. Thus, the forming time of the tear line groove 4 can be shortened.

Although an embodiment of the present invention has been described above, the present invention is not limited thereto. The detailed configuration may be appropriately changed within the scope of the present invention. For example, according to the embodiment described above, the groove width of the tear line groove in the vicinity of the branch end points 411, 412, 421, and 422 of the one Y-shape 41 and the other Y-shape 42 is larger than the groove width of the tear line groove in other portions, but alternatively, the groove width of the tear line groove near any one of the vicinities of the branch end points 411, 412, 421, and 422 may be made larger than the groove width of the tear line groove in the other portions.

### EXPLANATION OF REFERENCE NUMERALS

A . . . unicursal
SC . . . slide core
Ov . . . overlap processing portion
S1 . . . airbag deployment portion forming step
S2 . . . post-processing step
1 . . . instrument panel
2 . . . airbag
3 . . . airbag deployment portion
4 . . . tear line groove
5 . . . die
6 . . . end mill
41 . . . one Y-shape
41a. . . left branch
41b . . . right branch
41c . . . stem
41d . . . bottom point
42 . . . the other Y-shape
42a. . . left branch
42b . . . right branch
42c . . . stem
42d . . . bottom point
43 . . . central portion
43L . . . central straight portion
44 . . . quadrilateral
51 . . . movable die
52 . . . fixed die
53 . . . cavity
311 . . . O-shaped groove
312 . . . tapered portion
411, 412, 421, 422 . . . branch end point
441, 442, 443, 444 . . . end side
511 . . . ridge

What is claimed is:

1. A method of forming a tear line groove, which is a fragile portion against an inflation force of an airbag, in an airbag deployment portion of an instrument panel,
the tear line groove including: a central portion having a shape in which bottom points of two Y-shapes are connected to each other such that stems of the two Y-shapes are aligned in a straight line; and four end sides of a quadrilateral formed by connecting branch end points of one of the Y-shapes and the other of the Y-shapes in the shape of the central portion, the method comprising:
an airbag deployment portion forming step of applying, as one die of two dies constituting a cavity into which a molten resin is injected to form the airbag deployment portion, a die having a ridge protruding inwardly in the cavity to form two parallel end sides of the four end sides or to form two branches including one branch of left or right branch of the one Y-shape and any one of left or right branch of the other Y-shape; and
a post-processing step of processing the remaining tear line groove, which were not formed in the airbag deployment portion forming step.

2. The forming method according to claim 1, wherein the ridge of the one die used in the airbag deployment portion forming step is formed by arranging a slide core or an insert.

3. The forming method according to claim 1, wherein the two end sides facing each other are formed in the airbag deployment portion forming step, and
the remaining end sides are processed in the post-processing step, including overlap processing in which processing is performed in a state that the remaining side ends partially overlap with the two end sides which were formed in the airbag deployment portion forming step and which face each other.

4. The forming method according to claim 3, wherein a groove width of the tear line groove subjected to the overlap processing is processed so as to be larger than a groove width of the tear line groove not subjected to the overlap processing.

5. An instrument panel in which a tear line groove, which is a fragile portion against an inflation force of an airbag, is formed in an airbag deployment portion,
the tear line groove including: a central portion having a shape in which bottom points of two Y-shapes are connected to each other such that stems of the two Y-shapes are aligned in a straight line; and four end sides of a quadrilateral formed by connecting branch end points of one of the Y-shapes and the other of the Y-shapes in the shape of the central portion,
the tear line groove in a vicinity of each of branch end points of the one Y-shape and the other Y-shape having a groove width larger than a groove width of the tear line groove in other portions.

6. The instrument panel according to claim 5, wherein the groove width of the tear line groove in the vicinity of each of the branch end points of the one Y-shape and the other Y-shape is twice or less than the groove width of the tear line groove in the other portions.

7. The instrument panel according to claim 6, wherein the central portion and two of the end sides facing each other in the tear line groove form a groove that has substantially a U-shape in cross section, and a portion near a groove opening is formed in a tapered shape.

8. The instrument panel according to claim 5, wherein other portions of the tear line groove excepting the central portion and some of the four end sides continue to each other in a unicursal shape.

9. A method of forming a tear line groove, which is a fragile portion against an inflation force of an airbag, in an airbag deployment portion of an instrument panel,
an airbag deployment portion forming step of applying, as one die of two dies constituting a cavity into which a molten resin is injected to form the airbag deployment portion, a die having a ridge protruding inwardly in the cavity to form a part of the tear line groove; and
a post-processing step of processing the remaining tear line groove, which were not formed in the airbag deployment portion forming step.

10. The forming method according to claim 9, wherein the tear line groove has a first groove portion having a shape that allows unicursal writing among the tear line groove, and a second groove portion having a remaining shape that cannot be written with a unicursal writing of the tear line groove, and wherein in the airbag deployment portion forming step, the second groove portion is formed, and in the post-processing step, the first groove portion is machined.
